(19) United States
(12) Patent Application Publication
(10) Pub. No.: US 2014/0052534 A1
(43) Pub. Date: Feb. 20, 2014

(54) Electronic Advertising Targeting Multiple Individuals

(71) Applicant: Shaheen A. Gandhi, Seattle, WA (US)

(72) Inventor: Shaheen A. Gandhi, Seattle, WA (US)

(21) Appl. No.: 13/587,602

(22) Filed: Aug. 16, 2012

(51) Int. Cl. G06Q 30/02; G06Q 50/00

(52) U.S. Cl. CPC G06Q 30/0269; G06Q 50/01
USPC 705/14.58

(57) ABSTRACT

In one embodiment, a computer-implemented method involves identifying a plurality of individuals located within view of an electronic advertising display. The individuals are users of a social-networking system, and the social-networking system includes a graph that includes two or more nodes and edges connecting the nodes. For each user there is at least one node in the graph corresponding to the user. After the individuals are identified, one or more attributes of each of one or more of the individuals is determined from data associated with nodes in the graph corresponding to the individuals or data associated with edges connected to nodes corresponding to the individuals. The attributes are then provided for selection of an advertisement for presentation on the electronic advertising display to the individuals. The selection of the advertisement is based at least in part on one or more of the attributes.

### TECHNICAL FIELD

This disclosure generally relates to electronic advertising.

### BACKGROUND

Electronic advertising spaces provide advertisers with a venue for displaying electronic advertisements to consumers of the advertisement. Electronic advertising spaces may exist on electronic displays of various sizes. Displays may exist on mobile devices (such as smart phones), laptops, personal computers, televisions, kiosks, and billboards. An electronic advertising space may exist on a display in a public or private space, may contain advertisements intended to be viewed by a single person or multiple people, and may actually be viewed by a single person or multiple persons. For example, an advertising space on a billboard is intended to be viewed by multiple persons in the viewing area of the billboard. As another example, a television or monitor in a restaurant, retail store, or other business may be viewed by a large group of persons simultaneously or at different points in time. Likewise, even a display in a private space may be viewed by multiple persons. For example, a television in a private dwelling may be viewed by many members of a family or other groups sharing the dwelling space. Because electronic advertising spaces display advertisements that are electronic, the advertisements in the advertising spaces may be electronically changed as time progresses instead of requiring manual labor to change (e.g. as required for painted billboards).

### SUMMARY

In particular embodiments, an electronic advertising space may be viewed or may intended to be viewed by multiple consumers of an advertisement in the advertising space. For example, digital billboards or electronic displays in restaurants, businesses, or public or private structures may be viewed by multiple individuals. In particular embodiments, at least some of the individuals may be users of a social network containing nodes corresponding to individuals, concepts, or things and edges describing the connections or relationships among the various nodes.

Advertisements in the above-described advertising spaces may be targeted to the individuals in the proximity of the advertising space. In particular embodiments, the identity of the multiple individuals in the viewing area of an advertising space may be determined. Then, one or more attributes of the individuals may be determined. For example, attributes may be determined for express, inferred, or predicted information accessible to or stored in a social network. The determined attributes may then be provided for the selection of an advertisement, the determination of a bid for an advertising space, or both. In particular embodiments, the attributes used for the selection of an advertisement or bid may relate to an individual's age, gender, past behaviors, preferences, dislikes, interests, connections, employment status, income, purchasing power, memberships, education, relationships, physical orientation (such as direction facing), motion (such as direction or speed), or any other suitable characteristic. In particular embodiments, the selection of an advertisement of bid may be based on the percentage of identified individuals having a particular attribute, the absolute number of individuals having a particular attribute, or both.

### BRIEF DESCRIPTION OF THE DRAWINGS

FIG. 1 illustrates an example network environment.

FIG. 2 illustrates an example social network.

FIG. 3 illustrates an example method for computing a measurement of affinity.

FIGS. 4A-B illustrate an example personal computing device.

FIG. 5 illustrates an example software architecture for information and applications on a personal computing device.

FIG. 6 illustrates an example advertising network.

FIG. 7 illustrates an example method for targeting an advertisement to one or more individuals when multiple individuals are in the viewing area of the advertisement.

FIG. 8 illustrates an example computer system for performing particular embodiments.

### DESCRIPTION OF EXAMPLE EMBODIMENTS

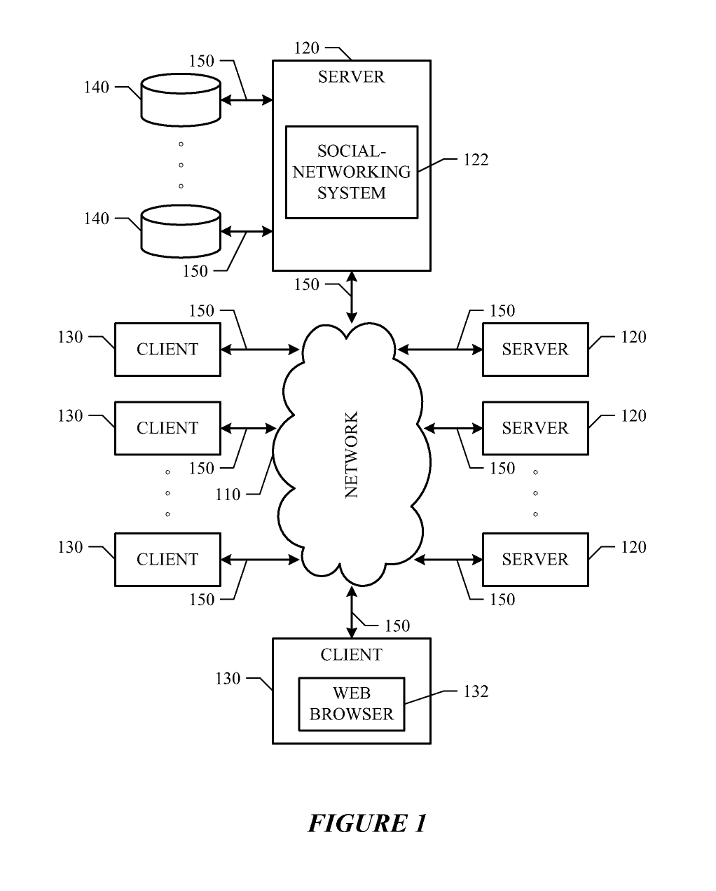

FIG. 1 illustrates an example network environment 100. Network environment 100 includes a network 110 coupling one or more servers 120 and one or more clients 130 to each other. In particular embodiments, network 110 is an intranet, an extranet, a virtual private network (VPN), a local area network (LAN), a wireless LAN (WLAN), a wide area network (WAN), a metropolitan area network (MAN), a portion of the Internet, a cellular technology-based network, a satellite communications technology-based network, or another network 110 or a combination of two or more such networks 110. This disclosure contemplates any suitable network 110.

One or more links 150 couple a server 120 or a client 130 to network 110. In particular embodiments, one or more links 150 each includes one or more wireline, wireless, or optical links 150. In particular embodiments, one or more links 150 each includes an intranet, an extranet, a VPN, a LAN, a WLAN, a WAN, a MAN, a portion of the Internet, a cellular technology-based network, a satellite communications technology-based network, or another link 150 or a combination of two or more such links 150. This disclosure contemplates any suitable links 150 coupling servers 120 and clients 130 to network 110.

In particular embodiments, each server 120 may be a unitary server or a distributed server spanning multiple computers or multiple datacenters. Servers 120 may be of various types, such as, for example and without limitation, web server, news server, mail server, message server, advertising server, file server, application server, exchange server, database server, proxy server, another server suitable for performing functions and/or processes described herein, or any combination thereof. In particular embodiments, each server 120 may include hardware, software, or embedded logic components or a combination of two or more such components for carrying out the appropriate functionalities implemented or supported by server 120. For example, a web server is generally capable of hosting websites containing web pages or particular elements of web pages. More specifically, a web server may host HTML files or other file types, or may dynamically create or constitute files upon a request, and communicate them to clients 130 in response to HTTP or other requests from clients 130. A mail server is generally capable of providing electronic mail services to various clients 130. A database server is generally capable of providing an interface for managing data stored in one or more data stores. In particular embodiments, a social-networking system 122 may be hosted on a server 120.

Various portions of social networking system 122 may be implemented via a hardware architecture or software framework that enables various software components or processes to implement particular embodiments, as is described in more detail, by way of example and not by way of limitation, below. The platform may include one or more hardware or software components, one or more of which may be located or embodied in one or more consolidated or distributed computing systems.

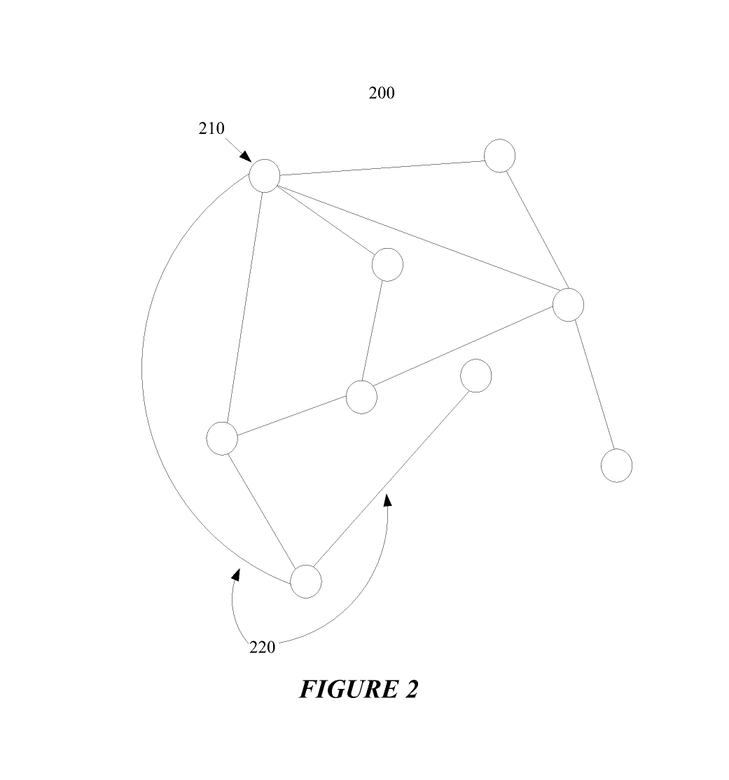

Particular embodiments relate to a social network environment that includes an infrastructure or platform (hereinafter infrastructure and platform may be used interchangeably) enabling an integrated social network environment. In the present disclosure, the social network environment may be described in terms of a social graph including social graph information. FIG. 2 illustrates an example social graph 200. In particular embodiments, one or more computing systems of a social network system implementing the social network environment include, store, or have access to one or more data structures that include a social graph for use in implementing the social network environment described herein. In particular embodiments, social graph 200 may have nodes 210 such as user nodes that each correspond to a respective user of the social network environment, concept nodes each devoted or directed to a particular concept, or topic nodes, which may or may not be ephemeral, each devoted or directed to a particular topic of current interest among users of the social network environment. In particular embodiments, each node 210 has, represents, or is represented by, a corresponding web page (“profile page”) hosted or accessible in the social network environment. By way of example, a user node may have a corresponding user profile page in which the corresponding user can add content, make declarations, and otherwise express himself or herself. By way of example, as will be described below, various web pages hosted or accessible in the social network environment such as, for example, user profile pages, concept profile pages, or topic profile pages, enable users to post content, post status updates, post messages, post comments including comments on other posts submitted by the user or other users, declare interests, declare a “like” (described below) towards any of the aforementioned posts as well as pages and specific content, or to otherwise express themselves or perform various actions (hereinafter these and other user actions may be collectively referred to as “posts” or “user actions”). In some embodiments, posting may include linking to, or otherwise referencing additional content, such as media content (e.g., photos, videos, music, text, etc.), uniform resource locators (URLs), and other nodes, via their respective profile pages, other user profile pages, concept profile pages, topic pages, or other web pages or web applications. Such posts, declarations, or actions may then be viewable by the authoring user as well as other users. In particular embodiments, social graph 200 further includes a plurality of edges 220 that each define or represent a connection between a corresponding pair of nodes 210 in social graph 200. This disclosure contemplates a social network having any suitable number of nodes representing any suitable entity, concept, or thing, and any suitable edges connecting the nodes.

In particular embodiments, information about the entity, concept, or thing a node represents and/or its relationships to other entities, concepts, or things may be determined from the social graph. In particular embodiments, a social network may store or access information corresponding to the entity, concept, or thing a node represents and/or the edges defining relationships among the nodes. Such information may be stored in any suitable data structure accessible by the social network, such as data structure 140 of FIG. 1. When such information is available in express form to the social network the information may be referred to as “express information”. For example, a user of a social network may directly indicate that he likes ice cream by selecting a “like” indicator accessible by the social network. This information is accessible by the social network and relates to the node representing the user and/or the node representing ice cream (or the particular brand of ice cream). Thus, that the user likes ice cream is information that can be expressly determined from or is directly accessible by the social graph. In particular embodiments, information about an entity, concept a thing may be inferred from information in the social graph relating to the entity, concept, or thing. Inferences may be made from express information relating to a node corresponding to the entity, concept, or thing; express information relating to the connections (stored in the social graph as edges) between a node and other nodes; or express information relating to other nodes in the social graph (for example, nodes that the node representing the entity, concept, or thing is connected to). In addition or the alternative, inferences may be made from other inferences made from express information accessible to the social network. As an example of inferring information, as described above express information may indicate that a user likes ice cream. Express information may also indicate that the user's nephew likes ice cream, and an edge may indicate that the user and his nephew are connected in the social network. Thus, the network may infer that the user and his nephew would enjoy having ice cream together. While the above example is a simple one, it illustrates that a social network may contain or access express information on a entity, concept, or thing, and that information about an entity, concept, or thing may be inferred from express information available to the network. As another example, a user may input information accessible by a social network describing where the user went to college but not the subject the user majored in. Thus, where the user went to college is express information relating to at least the user's node in the social graph. However, the user's major may be determined from express information in the network, such as for example other interests the user has expressed, networks or groups the user is in, or the majors of the user's college friends. While this disclosure describes specific examples of information expressly available to a social network and methods of inferring information, this disclosure contemplates any suitable type of express information available to a social network and any suitable method of inferring information relating to one or more nodes or edges in a social graph.

In particular embodiments, an affinity module associated with a social networking system provides a measure of affinity for or relevance of particular information about a user. A predictor module is responsible for computing a set of predictor functions that predict whether some information is relevant to a user (for example, whether a user would like something). Predictor functions use express or inferred information available to the social networking system as inputs to predict the relevance of information to the user. Information predicted about a user may include how likely a user is to take specific future actions, how likely a user is to enjoy a specific activity or thing, or a user's preferences, interests, personal and/or commercial habits, or personal or business contacts. Any suitable information (such as express or inferred information discussed above) accessible to a social network may be used in the computation of predictor functions and/or in the prediction of affinity's associated with a user.

Various processes may request a measure of affinity from the affinity module. As an example and not by way of limitation, the processes may include social-networking system 122 functionality, such as for example newsfeed algorithms, advertising-targeting algorithms, or friend-suggestion algorithms. Other processes that request measures of affinity may be executed by one or more platform applications, which are applications that operate within social-networking system 122 but may be provided by third parties other than an operator of the social-networking system 122 platform applications may include social games, messaging services, or any suitable application that uses the social platform provided by social-networking system 122. In some embodiments, the processes requesting a measure of affinity for a user may include one or more external applications running on an external server 120. For example, a third-party advertiser may request one or more measures of affinity for a user from the social-networking system 122. External applications may interact with social-networking system 122 via an API. The external applications can perform various operations supported by the API, such as enabling users to send each other messages through the social-networking system or showing advertisements routed through the social networking system 122.

In particular embodiments, the affinity module computes a requested measure of affinity by combining a weighted set of predictor functions, where each predictor function predicts whether particular information is relevant to a user. Weights are applied to predictor functions and then the weighted results of the predictor functions combined to obtain a measure of affinity. As an example and not by way of limitation, the weighted predictor functions are summed linearly. As another example, other methods of combining the predictor functions may be used, such as for example harmonic means, mean squares, and geometric means. The weighting of the predictor functions used to calculate the measure of affinity are provided by the process that requests the measure of affinity. Each process may the weigh the predictor functions differently to calculate the measure of affinity for a particular user, such that the affinity function is tunable by the process.

Additionally, multiple measures of affinity with varying weights may be computed before predicting whether information relevant to a user. The weights of the affinity function enable it to be used by various processes in the social-networking system environment for different purposes. For example, in a process that provides advertisements with social endorsements from a user's “friends”, an advertising algorithm may use the measure of affinity function to determine which of a user's “friends” to mention in the social endorsement or what type of actions to mention in the endorsement. In particular embodiments, the measure of affinity may be used to encourage more user interaction with the social networking system and enhance the user experience. The social-networking system may customize delivery of information to a viewing user executing a particular application on mobile-computing device 400 by employing algorithms to filter the raw content on the network. Content may be filtered based on information available to the social network, such as the user's geographic location, employer, job type, age, music preferences, interests, or other attributes, as well as based on the interests of the user with respect to another user who is related to the generated content (e.g., the user who performed an action that resulted in the content or information). Social endorsement information may be used to provide social context for advertisements presented to a particular user when using particular applications executed on mobile-computing device 400 or applications not native to the social-networking system. The measure of affinity may then be based on those predictor functions that indicate a level of interest the user might have in viewing the content posted by another user as well as one or more predictor functions that indicate a level of interest the user has in various actions that may be mentioned in the social endorsement.

As an example and not by way of limitation, an advertising algorithm may provide relatively large weights for these predictor functions so that the resulting measure of affinity would more accurately determine which social endorsements would be more interesting to the user. The advertisement algorithm may select the social endorsement using the resultant measure of affinity, thereby increasing the likelihood a click-through of the advertisement. As another example, in a process for a social-game application that seeks to invite connections of the user or send messages on behalf of the user, a social algorithm may use the measure of affinity function to determine which of a user's connections to suggest for invitation to the game or what type of messages to send on behalf of the user. The measure of affinity for this purpose may be based on the predictor functions that show how interested the user is in viewing the content posted by the user's connections and/or how often the users plays games with the user's connections in general, as well as one or more predictor functions that show how interested the user is posting different types of messages. Accordingly, the social algorithm would weight these predictor functions relatively high so that the resulting measure of affinity would accurately determine which connection(s) to suggest that the user invite and which invitations or messages would be more interesting to the viewing user, and then select the invitation or message using the resulting measure of affinity.

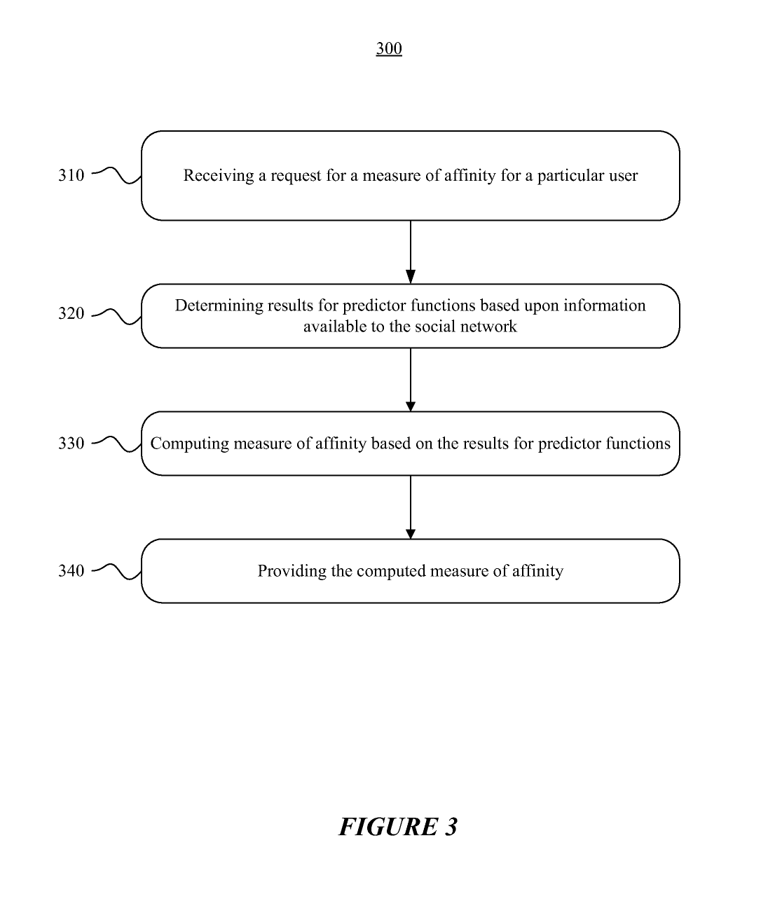

FIG. 3 illustrates an example method 300 for computing a measurement of affinity. Method 300 may start at step 310, where the social-networking system receives a request for a measure of affinity for some information associated with a user of the social-networking system. In particular embodiments, the measure of affinity is indicative of the relevance of the particular information to the user. At step 320, results for each of one or more predictor functions are determined based at least in part upon information available to the social networking system. In particular embodiments, each predictor function calculates a likelihood that some information is relevant to the user. Step 330 computes a measure of affinity associated with the user based on the results for one or more of the predictor functions. In particular embodiments, the measure of affinity is computed using a combination of the results of the predictor functions. At step 340, the computed measure of affinity is provided. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components carrying out particular steps of the method of FIG. 3, this disclosure contemplates any suitable combination of any suitable components carrying out any suitable steps of the method of FIG. 3.

In particular embodiments, when a user submits a post such as, by way of example, those described above, or performs some other action such as, by way of example, typing a word or query into a search box, clicking on a hyperlink, or even just visiting a particular page, the post or action is received or detected by the social network system described herein. The social network system analyzes the content of the post (e.g., the words, media, or other content in the post, or in the case of a “like”, the words, media, or other content in the “liked” post) or various information associated with the performed action (e.g., the word(s) entered in the search box, the information accessed when clicking the hyperlink, or the information provided in the requested web page) to determine or extract one or more topics of the post (e.g., the theme, main idea, or subject of the post) or topics associated with the performed action (e.g., the topic, theme, main idea, title, or subject of the search or accessed page). Subsequently, the social network system searches a database or index of topics and a correlated database of previously received posts from other users to identify any related posts from the other users that share one or more of the same or similar topics. In particular embodiments, the social network system then transmits for presentation to the user one or more related posts or information about the related posts including, by way of example, text or other content as well as, in particular embodiments, information regarding the authoring users of the related posts. In one implementation, the related posts may be transmitted in substantially real-time relative to the post submitted or action performed by the user such that the user is presented with one or more related posts in close temporal proximity. The identification and presentation of related posts form a basis for enabling spontaneous conversations around the topic or topics of the user's posts or actions and related posts. More particularly, the social network system may search a database or index of topics to identify one or more related posts stored in a database of posts having the greatest or at least a threshold relevance to the user's submitted post or detected action and present one or more of the related posts, or information associated with the related posts, to the user in one or more of a number of forms, and in particular embodiments, with one or more interactive elements. In particular embodiments, the interactive elements enable the user to view the related posts or information associated with the related posts and to comment on or otherwise interact with the related posts or the authoring users of the related posts by way of the interactive elements presented with the respective related posts or other information associated with the related posts. In this way, the social network environment facilitates interaction amongst the user and the authoring users of the related posts, and in particular embodiments, without additional input by the user submitting the post or performing the action. That is, in particular embodiments, the social network system searches and identifies related posts without requiring further instruction by the user after the user submits his or her own post or performs certain actions.

In various example embodiments one or more described web pages or web applications are associated with a social network environment or social networking service. As used herein, a “user” may be an individual (human user), an entity (e.g., an enterprise, business, or third party application), or a group (e.g., of individuals or entities) that interacts or communicates with or over such a social network environment. In the context of a social network, a “registered user” refers to a user that has officially registered within the social network environment. In particular embodiments, the users and user nodes described herein refer to registered users only. In particular embodiments, the users and user nodes described herein may refer to users that have not registered with the social network environment described herein. In particular embodiments, each user has a corresponding “profile” page stored, hosted, or accessible by the social network environment and viewable by all or a selected subset of other users. Generally, a user has administrative rights to all or a portion of his or her own respective profile page as well as, potentially, to other pages created by or for the particular user including, for example, home pages, pages hosting web applications, among other possibilities. In the context of a social networking environment, an “authenticated user” refers to a user who has been authenticated by the social network environment as being the user claimed in a corresponding profile page to which the user has administrative rights or, alternately, a suitable trusted representative of the claimed user.

Returning to the network environment of FIG. 1, in particular embodiments, one or more data storages 140 may be communicatively linked to one or more severs 120 via one or more links 150. In particular embodiments, data storages 140 may be used to store various types of information. In particular embodiments, the information stored in data storages 140 may be organized according to specific data structures. In particular embodiments, each data storage 140 may be a relational database. Particular embodiments may provide interfaces that enable servers 120 or clients 130 to manage, e.g., retrieve, modify, add, or delete, the information stored in data storage 140.

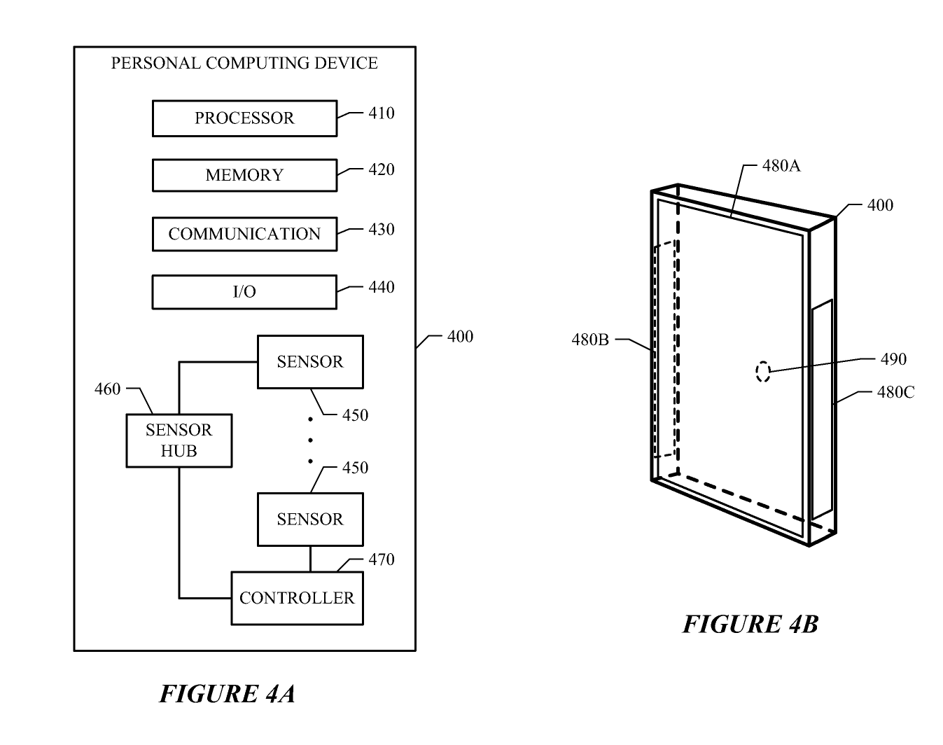

In particular embodiments, each client 130 may be an electronic device including hardware, software, or embedded logic components or a combination of two or more such components and capable of carrying out the appropriate functionalities implemented or supported by client 130. For example and without limitation, a client 130 may comprise a computer system such as: a desktop computer, a notebook or laptop, a netbook, a tablet, an e-book reader, a GPS device, a camera, a personal digital assistant (PDA), a handheld electronic device, a mobile telephone, or another similar processor-based electronic device. This disclosure contemplates any suitable clients 130. A client 130 may enable a network user at client 130 to access network 130. A client 130 may enable its user to communicate with other users at other clients 130. In particular embodiments, a client device 130 may comprise a personal computing device 400 as described in FIGS. 4A and 4B.

A client 130 may have a web browser 132, such as MICROSOFT® INTERNET EXPLORER®, GOOGLE CHROME™ or MOZILLA FIREFOX®, and may have one or more add-ons, plug-ins, or other extensions, such as TOOLBAR or YAHOO TOOLBAR®. A user at client 130 may enter a Uniform Resource Locator (URL) or other address directing the web browser 132 to a server 120, and the web browser 132 may generate a Hyper Text Transfer Protocol (HTTP) request and communicate the HTTP request to server 120. Server 120 may accept the HTTP request and communicate to client 130 one or more Hyper Text Markup Language (HTML) files responsive to the HTTP request. Client 130 may render a web page based on the HTML files from server 120 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT®, JAVA®, MICROSOFT® SILVERLIGHT®, combinations of markup language and scripts such as AJAX (Asynchronous Javascript® and XML), and the like. Herein, reference to a web page encompasses one or more corresponding web page files (which a browser may use to render the web page) and vice versa, where appropriate.

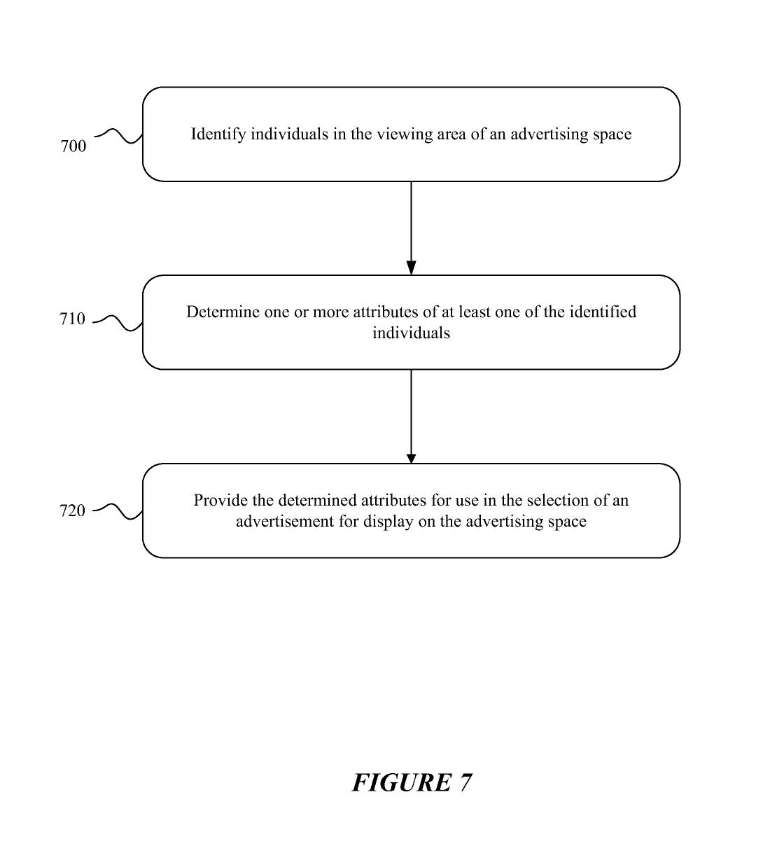

FIG. 4A illustrates an example personal computing device 400. In particular embodiments, personal computing device 400 may comprise a processor 410, a memory 420, a communication component 430 (e.g., antenna and communication interface for wireless communications), one or more input and/or output (I/O) components and/or interfaces 440, and one or more sensors 450. In particular embodiments, one or more I/O components and/or interfaces 440 may incorporate one or more sensors 450. In particular embodiments, personal computing device 400 may comprise a computer system or an element thereof as described in FIG. 7 and its associated description.

In particular embodiments, a personal computing device, such as a mobile device, may include various types of sensors 450, such as, for example and without limitation: touch sensors (disposed, for example, on a display of the device, the back of the device and/or one or more lateral edges of the device) for detecting a user touching the surface of the mobile electronic device (e.g., using one or more fingers); accelerometer for detecting whether the personal computing device 400 is moving and the speed of the movement; thermometer for measuring the temperature change near the personal computing device 400; proximity sensor for detecting the proximity of the personal computing device 400 to another object (e.g., a hand, desk, or other object); light sensor for measuring the ambient light around the personal computing device 400; imaging sensor (e.g., camera) for capturing digital still images and/or video of objects near the personal computing device 400 (e.g., scenes, people, bar codes, QR codes, etc.); location sensors (e.g., Global Positioning System (GPS)) for determining the location (e.g., in terms of latitude and longitude) of the mobile electronic device; sensors for detecting communication networks within close proximity (e.g., near field communication (NFC), Bluetooth, RFID, infrared); chemical sensors; biometric sensors for biometrics-based (e.g., fingerprint, palm vein pattern, hand geometry, iris/retina, DNA, face, voice, olfactory, sweat) authentication of user of personal computing device 400; etc. This disclosure contemplates that a personal computing device may include any applicable type of sensor. Sensors may provide various types of sensor data, which may be analyzed to determine the user's intention with respect to the mobile electronic device at a given time.

In particular embodiments, a sensors hub 460 may optionally be included in personal computing device 400. Sensors 450 may be connected to sensors hub 460, which may be a low power-consuming processor that controls sensors 450, manages power for sensors 450, processes sensor inputs, aggregates sensor data, and performs certain sensor functions. In addition, in particular embodiments, some types of sensors 450 may be connected to a controller 470. In this case, sensors hub 460 may be connected to controller 470, which in turn is connected to sensor 450. Alternatively, in particular embodiments, there may be a sensor monitor in place of sensors hub 460 for managing sensors 450.

In particular embodiments, in addition to the front side, personal computing device 400 may have one or more sensors for performing biometric identification. Such sensors may be positioned on any surface of personal computing device 400. In example embodiments, as the user's hand touches personal computing device 400 to grab hold of it, the touch sensors may capture the user's fingerprints or palm vein pattern. In example embodiments, while a user is viewing the screen of personal computing device 400, a camera may capture an image of the user's face to perform facial recognition. In example embodiments, while a user is viewing the screen of personal computing device 400, an infrared scanner may scan the user's iris and/or retina. In example embodiments, while a user is in contact or close proximity with personal computing device 400, chemical and/or olfactory sensors may capture relevant data about a user. In particular embodiments, upon detecting that there is a change in state with respect to the identity of the user utilizing personal computing device 400, either by itself or in combination with other types of sensor indications, personal computing device 400 may determine that it is being shared.

In particular embodiments, in addition to the front side, the personal computing device 400 may have touch sensors on the left and right sides. Optionally, the personal computing device 400 may also have touch sensors on the back, top, or bottom side. Thus, as the user's hand touches personal computing device 400 to grab hold of it, the touch sensors may detect the user's fingers or palm touching personal computing device 400. In particular embodiments, upon detecting that there is a change in state with respect to a user touching personal computing device 400, either by itself or in combination with other types of sensor indications, personal computing device 400 may determine that it is being shared.

In particular embodiments, personal computing device 400 may have an accelerometer in addition to or instead of the touch sensors on the left and right sides. Sensor data provided by the accelerometer may also be used to estimate whether a new user has picked up personal computing device 400 from a resting position, e.g., on a table or desk, display shelf, or from someone's hand or from within someone's bag. When the user picks up personal computing device 400 and brings it in front of the user's face, there may be a relatively sudden increase in the movement speed of personal computing device 400. This change in the device's movement speed may be detected based on the sensor data supplied by the accelerometer. In particular embodiments, upon detecting that there is a relatively significant increase in the speed of the device's movement, either by itself or in combination with other types of sensor indications, personal computing device 400 may determine that it is being shared.

In particular embodiments, personal computing device 400 may have a Gyrometer in addition or instead of the touch sensors on the left and right sides. A Gyrometer, also known as a gyroscope, is a device for measuring the orientation along one or more axis. In particular embodiments, a Gyrometer may be used to measure the orientation of personal computing device 400. When personal computing device 400 is stored on a shelf or in the user's bag, it may stay mostly in one orientation. However, when the user grabs hold of personal computing device 400 and lifts it up and/or moves it closer to bring it in front of the user's face, there may be a relatively sudden change in the orientation of personal computing device 400. The orientation of personal computing device 400 may be detected and measured by the gyrometer. If the orientation of personal computing device 400 has changed significantly, In particular embodiments, upon detecting that there is a relatively significant change in the orientation of personal computing device 400, either by itself or in combination with other types of sensor indications, personal computing device 400 may determine that it is being shared.

In particular embodiments, personal computing device 400 may have a light sensor. When personal computing device 400 is stored in a user's pocket or case, it is relatively dark around personal computing device 400. On the other hand, when the user brings personal computing device 400 out of his pocket, it may be relatively bright around personal computing device 400, especially during day time or in well-lit areas. The sensor data supplied by the light sensor may be analyzed to detect when a significant change in the ambient light level around personal computing device 400 occurs. In particular embodiments, upon detecting that there is a relatively significant increase in the ambient light level around personal computing device 400, either by itself or in combination with other types of sensor indications, personal computing device 400 may determine that it is being shared.

In particular embodiments, personal computing device 400 may have a proximity sensor. The sensor data supplied by the proximity sensor may be analyzed to detect when personal computing device 400 is in close proximity to a specific object, such as the user's hand. For example, mobile device 400 may have an infrared LED (light-emitting diode) 490 (i.e., proximity sensor) placed on its back side. When the user holds such a mobile device in his hand, the palm of the user's hand may cover infrared LED 490. As a result, infrared LED 490 may detect when the user's hand is in close proximity to mobile device 400. In particular embodiments, upon detecting that personal computing device 400 is in relatively close proximity to the user's hand, either by itself or in combination with other types of sensor indications, personal computing device 400 may determine that it is being shared.

A personal computing device 400 may have any number of sensors of various types, and these sensors may supply different types of sensor data. Different combinations of the individual types of sensor data may be used together to detect and estimate a user's current intention with respect to personal computing device 400 (e.g., whether the user really means to take personal computing device 400 out of his pocket and use it). Sometimes, using multiple types of sensor data in combination may yield a more accurate, and thus better, estimation of the user's intention with respect to personal computing device 400 at a given time than only using a single type of sensor data. Nevertheless, it is possible to estimate the user's intention using a single type of sensor data (e.g., touch-sensor data).

FIG. 4B illustrates the exterior of an example personal computing device 400. Personal computing device 400 has approximately six sides: front, back, top, bottom, left, and right. Touch sensors may be placed anywhere on any of the six sides of personal computing device 400. For example, in FIG. 4B, a touchscreen incorporating touch sensors 480A is placed on the front of personal computing device 400. The touchscreen may function as an input/output (I/O) component for personal computing device 400. In addition, touch sensors such as touch sensors 480B and 480C may be placed on the left and right sides of personal computing device 400, respectively. Touch sensors 480B and 480C may detect a user's hand touching the sides of personal computing device 400. In particular embodiments, touch sensors 480A, 480B, 480C may be implemented using resistive, capacitive, and/or inductive touch sensors. The electrodes of the touch sensors 480A, 480B, 480C may be arranged on a thin solid piece of material or a thin wire mesh. In the case of capacitive touch sensors, there may be two types of electrodes: transmitting and receiving. These electrodes may be connected to a controller (e.g., controller 470 illustrated in FIG. 4A), which may be a microchip designed to drive the transmitting electrodes with electrical pulses and measure the changes in capacitance from the receiving electrodes caused by a user's touches in order to detect the locations of the user touches.

Of course, personal computing device 400 is merely an example. In practice, a device may have any number of sides, and this disclosure contemplates devices with any number of sides. The touch sensors may be placed on any side of a device, and this disclosure contemplates a device containing any suitable number and type of touch sensors.

In particular embodiments, personal computing device 400 may have a proximity sensor 490 (e.g., an infrared LED) placed on its back side. Proximity sensor 490 may be able to supply sensor data for determining its proximity, and thus the proximity of personal computing device 400, to another object.

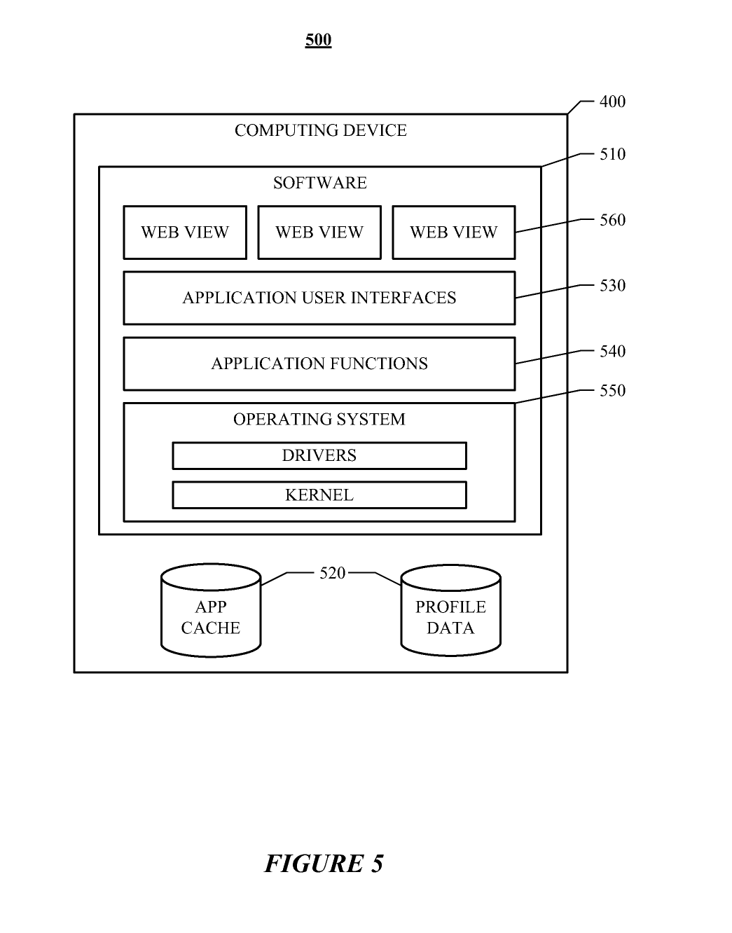

FIG. 5 illustrates an example software architecture 500 for information and applications on a personal computing device 500. In particular embodiments, software architecture 500 may comprise software 510 and data store(s) 520. In particular embodiments, personal information may be stored in an application data cache 520 and/or a profile data store 520 and/or another data store 520. In particular embodiments, one or more software applications may be executed on personal computing device 500. In particular embodiments, they may be web-based applications hosted on servers. For example, a web-based application may be associated with a URI (Uniform Resource Identifier) or URL (Uniform Resource Locator). From personal computing device 500, a user may access the web-based application through its associated URI or URL (e.g., by using a web browser). Alternatively, in other embodiments, they may be native applications installed and residing on personal computing device 500. Thus, software 510 may also include any number of application user interfaces 530 and application functions 540. For example, one application (e.g., Google Maps®) may enable a device user to view a map, search for addresses and businesses, and get directions; a second application may enable the device user to read, send, and receive emails; a third application (e.g., a web browser) may enable the device user to browse and search the Internet; a fourth application may enable the device user to take photos or record videos using personal computing device 500; a fifth application may allow the device user to receive and initiate VoIP and/or cellular network calls, and so on. Each application has one or more specific functionalities, and the software (e.g., one or more software modules) implementing these functionalities may be included in application functions 540. Each application may also have a user interface that enables the device user to interact with the application, and the software implementing the application user interface may be included in application user interfaces 530. In particular embodiments, the functionalities of an application may be implemented using JavaScript®, Java®, C, or other suitable programming languages. In particular embodiments, the user interface of an application may be implemented using HyperText Markup Language (HTML), JavaScript®, Java®, or other suitable programming languages.

In particular embodiments, the user interface of an application may include any number of screens or displays. In particular embodiments, each screen or display of the user interface may be implemented as a web page. Thus, the device user may interact with the application through a series of screens or displays (i.e., a series of web pages). In particular embodiments, operating system 550 is Google's Android™ mobile technology platform. With Android®, there is a Java® package called “android.webkit”, which provides various tools for browsing the web. Among the “android.webkit” package, there is a Java class called “android.webkit.WebView”, which implements a View for displaying web pages. This class uses the WebKit rendering engine to display web pages and includes methods to navigate forward and backward through a history, zoom in, zoom out, perform text searches, and so on. In particular embodiments, an application user interface 530 may utilize Android's WebView application programming interface (API) to display each web page of the user interface in a View implemented by the “android.webkit.WebView” class. Thus, in particular embodiments, software 510 may include any number of web views 560, each for displaying one or more web pages that implement the user interface of an application.

During the execution of an application, the device user may interact with the application through its user interface. For example, the user may provide inputs to the application in various displays (e.g., web pages). Outputs of the application may be presented to the user in various displays (e.g., web pages) as well. In particular embodiments, when the user provides an input to the application through a specific display (e.g., a specific web page), an event (e.g., an input event) may be generated by, for example, a web view 560 or application user interfaces 530. Each input event may be forwarded to application functions 540, or application functions 540 may listen for input events thus generated. When application functions 540 receive an input event, the appropriate software module in application functions 540 may be invoked to process the event. In addition, specific functionalities provided by operating system 550 and/or hardware (e.g., as described in FIGS. 1 and 4A-B) may also be invoked. For example, if the event is generated as a result of the user pushing a button to take a photo with personal computing device 500, a corresponding image processing module may be invoked to convert the raw image data into an image file (e.g., JPG or GIF) and store the image file in the storage 520 of personal computing device 500. As anther example, if the event is generated as a result of the user selecting an icon to compose an instant message, the corresponding short message service (SMS) module may be invoked to enable the user to compose and send the message.

In particular embodiments, when an output of the application is ready to be presented to the user, an event (e.g., an output event) may be generated by, for example, a software module in application functions 540 or operating system 550. Each output event may be forwarded to application user interfaces 530, or application user interfaces 530 may listen for output events thus generated. When application user interfaces 530 receive an output event, it may construct a web view 560 to display a web page representing or containing the output. For example, in response to the user selecting an icon to compose an instant message, an output may be constructed that includes a text field that allows the user to input the message. This output may be presented to the user as a web page and displayed to the user in a web view 560 so that the user may type into the text field the message to be sent.

The user interface of an application may be implemented using a suitable programming language (e.g., HTML, JavaScript®, or Java®). More specifically, in particular embodiments, each web page that implements a screen or display of the user interface may be implemented using a suitable programming language. In particular embodiments, when a web view 560 is constructed to display a web page (e.g., by application user interfaces 530 in response to an output event), the code implementing the web page is loaded into web view 560.

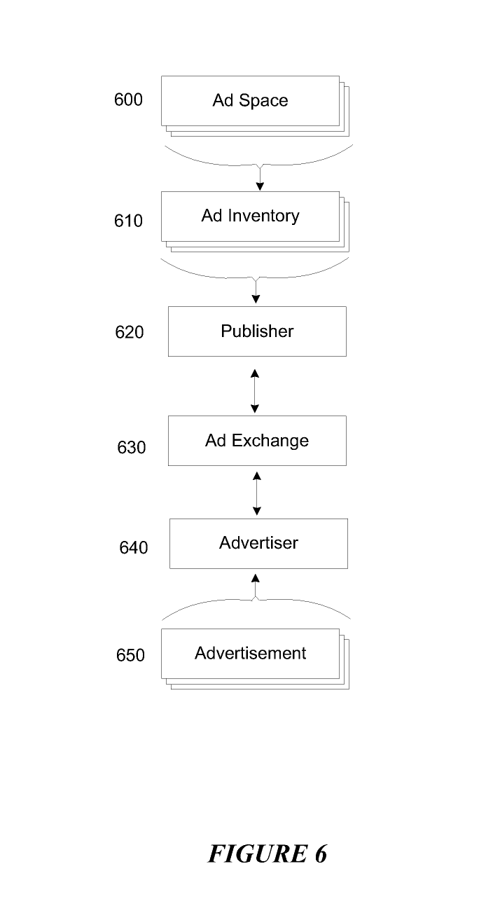

FIG. 6 illustrates an example electronic-advertising network. Electronic advertising spaces 600 provide advertisers 640 with a venue for displaying electronic advertisements 650 to consumers of the advertisement. As used herein, “consumers” of an advertisement include individuals who are in or may soon be in the viewing area of an advertisement, whether or not the individual actually is viewing the advertisement. Electronic advertisements 650 may be displayed on mobile devices (such as smart phones), laptops, personal computers, televisions, kiosks, billboards or any other suitable electronic device or display. An advertising space 600 may be part of any suitable content electronically displayed. For example, an advertising space 600 may be part of a web page.

In particular embodiments, an advertiser 640 may own an advertising space 600 in which to place ads. In particular embodiments, an advertising space 600 may be owned by a publisher 620 of advertisements. A publisher 620 may own one or more advertising spaces 600 in one or more advertising inventories 610, and may directly sell or rent one or more advertising spaces 600 to an advertiser 650. As an example, when an advertising space 600 in a publisher's inventory 610 becomes available the publisher 620 may notify one or more advertisers 650 of the available advertising space. In particular embodiments, publishers 620 and advertisers 650 may use a third-party service to facilitate purchasing of advertising space. For example, a publisher may notify one or more ad exchanges 630 when advertising spaces 600 in the publisher's advertising inventory 610 become available, and the ad exchange 630 may notify advertisers 650 of the available ad spaces 600 and receive response and/or payment from the advertisers to place advertisements 650 in the one or more ad spaces 600. Example ad exchanges may include, without limitation, AdENC, RIGHT MEDIA, and DOUBLECLICK. In particular embodiments, an advertiser may communication with an ad exchange or a publisher via an advertising broker.

In particular embodiments, advertisers acquire the right to place an advertisement in a publisher's advertising space by placing one or more bids for advertising space. Bids for an advertising space may be based on any suitable metric or set of metrics, for example and not by way of limitation cost per impression (cost for each impression of advertisement), cost per mille (cost for each thousand impressions of advertisement), cost per click (cost for each click on advertisement), or cost per action or acquisition (cost for each specified action, such as conversion, purchase, or form submission) basis. In particular embodiments, bids may be based on any suitable information about the ad space or potential consumers of a advertisement. As an example, a bid may be based on the format of an ad space or the context the ad space appears in. As another example, a bid may be based on characteristics of one or more potential consumers of the advertisement, such as the consumers' age, preferences, income, prior actions, etc. This disclosure contemplates basing one or more bids on any suitable information about an advertising space or about potential consumers of the advertisement.

An electronic advertising space may exist on a display in a public or private place, may contain advertisements intended to be viewed by a single person or multiple people, and may actually be viewed by a single person or multiple persons. For example, an advertising space on a billboard is intended to be viewed by multiple persons in the viewing area of the billboard. As another example, a television or monitor in a restaurant, retail store, or other business may be viewed by a large group of persons simultaneously or at different points in time. Likewise, even a display in a private space may be viewed by multiple persons. For example, a television in a private dwelling may be viewed by many members of a family or other groups sharing the dwelling space.

Advertisements may be targeted to a potential consumer of the advertisement. In particular embodiments, advertisements may be targeted to more than one potential consumer of the advertisement. In particular embodiments, advertisements meant to be displayed to multiple viewers (e.g. a billboard) may be targeted to one or more potential consumer of the advertisement. For example, an advertiser may select an advertisement to display in an electronic advertising space based on attributes of a potential consumer of the advertisement. FIG. 7 illustrates an example method for targeting an advertisement to one or more consumers when multiple consumers are in the viewing area of the advertisement. The method may start at step 700, where information identifying individuals in the viewing area of an advertising space is determined. Information identifying an individual in the viewing area of an advertising space may include any suitable information expressly or implicitly determining the identity of an individual in the viewing area of the advertising space. For example, an individual may have a mobile device, such as the example device 400 of FIG. 4, that identifies a user, for example by a unique phone number associated with the device, the fact that a user has identified himself to the device by e.g. a login, or by any suitable sensors 450 described above. As another example, software such as an application on a device may identify an individual. For example, a social networking application may contain a profile unique to a user of the social network, and thus is able to identify a user when the application is active or the user is using the application. In particular embodiments, identifying an individual includes receiving information identifying an individual. Such information may be received from any suitable component or data structure of a network, device, or computing system as described herein. In particular embodiments, information may be received by any suitable component or data structure that resides within the same network, device, or computing system containing the components or data structure transmitting the information. In particular embodiments, information may be received by any suitable component or data structure in a network, device, or computing system that is external to or separate from the network, device, or computing system containing the components or data structure transmitting the information. While this disclosure provides examples of specific methods of identifying an individual, this disclosure contemplates any suitable method of determining the identity of an individual.

When an individual is capable of being identified, a determination may be made that the individual is in the viewing area of the electronic advertising space. As used herein, the viewing area of an advertising space includes areas from where the advertising space may be viewed and areas which are relatively nearby the areas where an advertising space may be viewed. As a result, the viewing area of an advertising space may depend on the environment of the advertising space (such as the surrounding geography), the size of the advertising space, the number of individuals nears the advertising space, the direction(s) the advertising space is facing, the velocity of an individual relative to the advertising space, or any other suitable factor that may affect from what areas an advertising space may be viewed. For example, a relatively small advertising space in an enclosed building has a smaller viewing area than an advertising space on a billboard or on the side of an unobstructed building. As another example, an individual who is heading in the direction of an advertising space may be determined to be in the viewing area of the advertising space if the advertising space may soon be in view of the individual. As a result, the speed of the individual will impact the viewing area of the advertising space. For example, the viewing area of a billboard on the side of a freeway may be larger than the viewing area of a billboard in a park that only has walking paths. While this disclosure provides specific examples of the viewing areas of advertising spaces, this disclosure contemplates a viewing area as any suitable location from where an advertising space may be viewed or soon viewed by an individual.

When an individual is capable of being identified, a determination may be made that the individual is in the viewing area of the electronic advertising space. This requires that the location of the user relative to the advertising space is known. In particular embodiments, both the location of the advertising space and the individual may be known. For example, the location of the advertising space such as a billboard or an electronic display in a store may be pre-determined by an advertiser, an ad publisher, an advertising exchange, the provider of content to the advertising space, or any other suitable entity. The location of an individual may be determined by any suitable device or application. For example, a device may have hardware or software, such as GPS-capable hardware and corresponding software, capable of determining a user's location automatically or upon request. Other methods of a device determining a user's location are described in the discussion of FIG. 4, above. As another example, the location of a user may be determined from an application such as a social networking application, which may determine a user's location from express information, such as the identification of the user's location in posts or check-ins, or from inferred information, such as a post stating that a user is shopping a particular store or driving along a particular stretch of road. In particular embodiments, only the relative location of the individual to an advertising space is known. For example, a user's device and hardware associated with the advertising space may communicate with each other by any suitable signals, such as Bluetooth, near-field communications (NFC), optical signals, or radio frequency to determine that a user is in the viewing area of the advertising space. For example, a user may hold his device near an NFC circuit that is part of or known to be in the proximity of an advertising space. The NFC communication establishes that a the user is near the circuit and thus also near the advertising space. While this disclosure provides specific examples of determining that an individual is in the viewing proximity of an advertising space, this disclosure contemplates any suitable method of or hardware or software for determining the location of an individual, an advertising space, or the relative location of the two.

After the individuals in the viewing area of an advertising space are identified, the method of FIG. 7 moves to step 710, where attributes of the individuals are determined. In this context, an “attribute” is any suitable information or characteristic describing or associated with an individual, such as the individuals likes, preferences, relationships, activities, interests, habits, possessions, etc. Attributes of an individual may be determined from information stored on any suitable storage media, for example data structure 140 in the example network 100 of FIG. 1 or memory 420 of device of example device 400 illustrated in FIG. 4. In particular embodiments, an individual may be a user of a social network and attributes of the individual may be determined from any suitable express, inferred, or predicted information available to or computable by the social network, as described above. In particular embodiments, determining attributes of an individual includes receiving determined attributes of an individual. Such attributes may be received from any suitable component or data structure of a network, device, or computing system as described herein. In particular embodiments, attributes may be received by any suitable component or data structure that resides within the same network, device, or computing system containing the components or data structure transmitting the attributes. In particular embodiments, attributes may be received by any suitable component or data structure in a network, device, or computing system that is external to or separate from the network, device, or computing system containing the components or data structure transmitting the attributes. While this disclosure describes specific examples methods of determining the attributes of an individual, this disclosure contemplates any suitable method of determining the attributes of a user.

After the attributes of one or more individuals in the viewing area of an advertising space are determined, the determined attributes are provided in step 720 for selection of an advertisement, a bid for an advertising space, or both. The selection of an advertisement or bid for an advertising space is based on at least one of the attributes determined in step 710. The selection of an advertisement may be made by any suitable entity, such as for example the entity determining the attributes, an advertiser, the publisher of an advertising space, an ad exchange, an agent of an entity, or any suitable combination thereof. This disclosure contemplates any suitable determined attributes may be used in the selection of an advertisement. For example, attributes relevant to an advertisement selection may be one or more of an individual's age, gender, past behaviors, preferences, dislikes, interests, connections, employment status, income, purchasing power, memberships, education, relationships, orientation (such as direction facing), motion (such as direction or speed), time of day, location, interactions with a social network, interactions with a device, or any other suitable attributes. In particular embodiments, attributes relevant to the selection of an advertisement may be specified by the entity selecting the advertisements. For example, an advertiser may receive all determined attributes, or all determined attributes corresponding to the parameters of an advertiser's request, and consider those attributes the advertiser determines are most relevant to advertising selection. In particular embodiments, attributes used for the selection of an advertisement may be at least in part specified by an entity other than the entity selecting the advertisement. For example, the entity determining the attributes, such as a social network, may implement algorithms to determine which attributes are desirable for particular advertisers or industries and then send these pre-sorted attributes to an entity for selection of an advertisement.

In particular embodiments, the selection of an advertisement or a bid for an advertising space may be based on one or more determined attributes of multiple identified individuals in the viewing area of the advertising space. In particular embodiments a bid or advertising selection may be based on the percentage of identified individuals having one or more specific determined attributes. For example, an advertiser for a particular brand of laptop may be willing to start bidding on an advertising space if the percentage of individuals who have previously purchased the brand of laptop, expressed an interest in purchasing the brand of laptop, or are otherwise are predicted to be interested purchasing the brand of laptop reaches a pre-determined threshold (for example, 30%). The advertiser may increase their bid as the percentage of individuals having one of the specified attributes above increases. In particular embodiments, the bid amount may also depend on the predicted likelihood that one or more individuals are interested in purchasing the brand of laptop. For example, if only 20% of users are predicted to be interested in purchasing the brand of laptop, but the predicted interest of those individuals is very high, the advertiser may be willing to bid or bid a larger amount for the advertising space. As another example, the selection of an ad may be based on the percentage of individuals associated with a particular attribute, such as the dislike for a competitor's product versus the like for the advertiser's product. For example, if a given percentage of individuals are determined to like a particular sports team, such as the Seattle Seahawks, the Seahawks may select on ad focusing on team support such as “Go Hawks! 10% off merchandise now.” In contrast, if a given percentage of individuals are determined to dislike the sport team's rivals, for example the San Francisco 49ers, the team may select an ad focusing on distaste for the rival, such as “Let your voices be heard . . . boo the Niners with us tonight! Tickets on sale now.” Thus, the selection of a particular ad may be based on how the attributes of a percentage of identified individuals indicate interest or potential interest in an advertisement. In particular embodiments, selection of an ad or a bid for an ad may be based on the absolute number of identified individuals having one or more specific determined attributes. For example, an advertiser of silk sheets may be willing to bid more on an advertising space as the total number of individuals interested in silk sheets and in the area of the advertising space increases. For example, the advertiser may be willing to bid a larger amount on the advertising space if 1000 individuals are interested or have a potential interest in silk sheets than if only 10 individuals are interested or potentially interested in silk sheets, even if the 10 individuals represent a high percentage of the individuals in the viewing area of the advertising space. As another example, an advertiser of luxury goods may be willing to bid for an advertising space if a small number of individuals are interested or potentially interested in purchasing the luxury goods, even if the absolute number or percentage of individuals is relatively small. Likewise, an advertisement geared towards high-income individuals may be selected over an advertisement geared towards low-income individuals, even when the number of low-income individuals is greater than the number of high-income individuals. In particular embodiments, selection of an ad or a bid for an ad may be based on the velocity of one or more individuals in the view are of the advertising space. For example, an advertiser may be willing to bid more for an ad space if individuals are more likely to be orientated in the direction of the ad space or are passing through the viewing area of the advertising space more slowly. As another example, an advertiser may select a simpler advertisement when individuals' velocities indicates they are more likely to pass by the advertisement quickly and a more complex, richer ad when individuals' velocities indicates they are more likely to pass by the advertisement slowly. In particular embodiments, selection of an ad or a bid for an ad may be based on the number of times one or more individuals have been exposed to the ad or similar ads. For example, if many individuals have seen an ad once, the advertiser may be more willing to display that ad again. In contrast, if individuals have seen an ad tens of times, the advertiser may display a different ad or avoid bidding on the ad space altogether. While this disclosure provides specific examples of the attributes used to select an advertisement or bid, methods of determining how attributes of multiple individuals influences the selection of an ad or bid, and the entity selecting the ad or bid, this disclosure contemplates any suitable attributes used to select an advertisement or bid, methods of determining how attributes of multiple individuals influences the selection of an ad or bid, and the entity selecting the ad or bid.

Particular embodiments may repeat the steps of the method of FIG. 7, where appropriate. Moreover, although this disclosure describes and illustrates particular steps of the method of FIG. 7 as occurring in a particular order, this disclosure contemplates any suitable steps of the method of FIG. 7 occurring in any suitable order. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

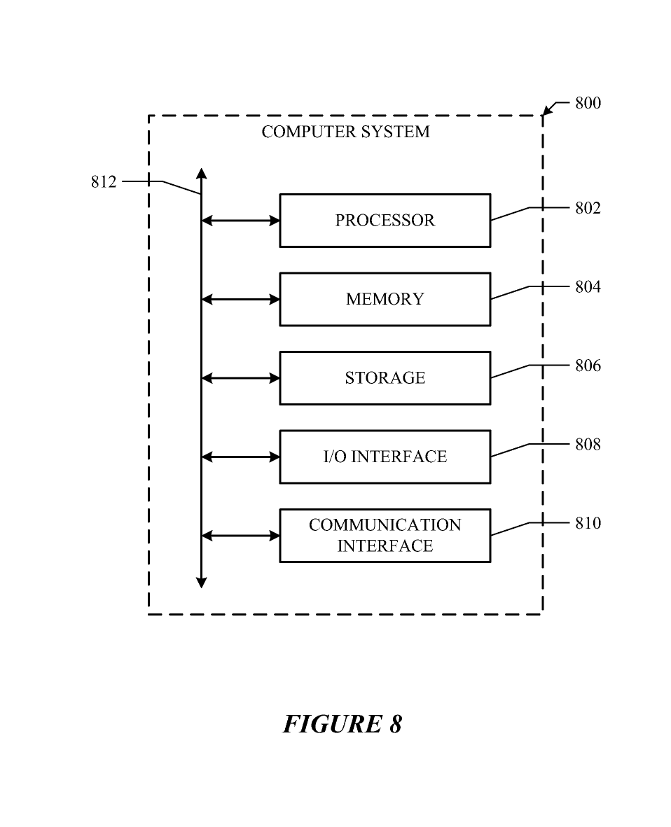

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple datacenters; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. Although this disclosure describes and illustrates particular memory, this disclosure contemplates any suitable memory.

In particular embodiments, storage 806 includes mass storage for data or instructions. Storage 806 may include removable or non-removable (i.e., fixed) media, where appropriate. Storage 806 may be internal or external to computer system 800, where appropriate. In particular embodiments, storage 806 is non-volatile, solid-state memory. Where appropriate, storage 806 may include one or more storages 806. Although this disclosure describes and illustrates particular storage, this disclosure contemplates any suitable storage.

In particular embodiments, I/O interface 808 includes hardware, software, or both providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 810 for it. Although this disclosure describes and illustrates a particular communication interface, this disclosure contemplates any suitable communication interface.

In particular embodiments, bus 812 includes hardware, software, or both coupling components of computer system 800 to each other. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, identifying a plurality of individuals located within view of an electronic advertising display, the individuals being users of a social-networking system, the social-networking system comprising a graph that comprises a plurality of nodes and edges connecting the nodes, for each user at least one node in the graph corresponding to the user;
by the computing device, determining one or more attributes of each of one or more of the individuals from data associated with nodes in the graph corresponding to the individuals or data associated with edges connected to nodes corresponding to the individuals; and
by the computing device, providing the attributes for selection of an advertisement to present by the electronic advertising display to the individuals, the selection based at least in part on one or more of the attributes.

2. The method of claim 1, wherein identifying the plurality of individuals located within view of the electronic advertising display comprises receiving information identifying a plurality of individuals located within view of an electronic advertising display.

3. The method of claim 1, wherein determining one or more attributes of each of one or more of the individuals comprises receiving one or more attributes of each of one or more of the individuals in response to a query for one or more attributes of each of one or more of the individuals.

4. The method of claim 1, wherein providing the attributes for selection of an advertisement to present by the electronic advertising display comprises selecting an advertisement to present by the electronic display based on the provided attributes.

5. The method of claim 1, further comprising, by the computing device:
receiving a plurality of bids, each bid associated with one or more advertisements;
selecting a bid from the plurality of bids; and
selecting the advertisement to present by the electronic advertising display to the individuals, the selection based at least in part on the bid selected from the plurality of bids.

6. The method of claim 5, wherein at least one of the plurality of bids is based at least in part on the one or more attributes of each of one or more of the individuals.

7. The method of claim 1, wherein at least one of the one or more attributes of each of one or more of the individuals is determined from express information associated with:
nodes in the graph corresponding to one or more of the individuals; or
edges connected to nodes corresponding to one or more of the individuals.

8. The method of claim 1, wherein at least one of the one or more attributes of each of one or more of the individuals is determined from implicit information inferred from express information associated with:
nodes in the graph corresponding to one or more of the individuals; or
edges connected to nodes corresponding to one or more of the individuals.

9. The method of claim 1, wherein at least one of the one or more attributes of each of one or more of the individuals comprises one or more of:
a location;
a velocity; or
an orientation.

10. The method of claim 1, wherein at least one of the one or more attributes of each of one or more of the individuals comprises the number of times an individual has been exposed to one or more advertisements.

11. The method of claim 1, wherein the selection of an advertisement to present by the electronic advertising display to the individuals is based at least in part on:
a number of individuals associated with an attribute;
a percentage of individuals associated with an attribute; or
a velocity of one or more of the individuals.

12. One or more computer-readable non-transitory storage media embodying software that is operable when executed to:
identify a plurality of individuals located within view of an electronic advertising display, the individuals being users of a social-networking system, the social-networking system comprising a graph that comprises a plurality of nodes and edges connecting the nodes, for each user at least one node in the graph corresponding to the user;
determine one or more attributes of each of one or more of the individuals from data associated with nodes in the graph corresponding to the individuals or data associated with edges connected to nodes corresponding to the individuals; and
provide the attributes for selection of an advertisement to present by the electronic advertising display to the individuals, the selection based at least in part on one or more of the attributes.

13. The media of claim 12, wherein the software operable to identify the plurality of individuals located within view of the electronic advertising display comprises software operable to receive information identifying a plurality of individuals located within view of an electronic advertising display.

14. The media of claim 12, wherein the software operable to determine one or more attributes of each of one or more of the individuals comprises software operable to receive one or more attributes of each of one or more of the individuals in response to a query for one or more attributes of each of one or more of the individuals.

15. The media of claim 12, wherein the software operable to provide the attributes for selection of an advertisement to present by the electronic advertising display comprises software operable to select an advertisement to present by the electronic display based on the provided attributes.

16. The media of claim 12, the software further operable to:
receive a plurality of bids, each bid associated with one or more advertisements;
select a bid from the plurality of bids; and
select the advertisement to present by the electronic advertising display to the individuals, the selection based at least in part on the bid selected from the plurality of bids.

17. The media of claim 16, wherein at least one of the plurality of bids is based at least in part on the one or more attributes of each of one or more of the individuals.

18. The media of claim 12, wherein the software is further operable to determine at least one of the one or more attributes of each of one or more of the individuals from express information associated with:
nodes in the graph corresponding to one or more of the individuals; or
edges connected to nodes corresponding to one or more of the individuals.

19. The media of claim 12, wherein the software is further operable to determine at least one of the one or more attributes of each of one or more of the individuals from implicit information inferred from express information associated with:
nodes in the graph corresponding to one or more of the individuals; or
edges connected to nodes corresponding to one or more of the individuals.

20. A system comprising:
one or more processors; and
a memory coupled to the processors comprising instructions executable by the processors, the processors operable when executing the instructions to:
identify a plurality of individuals located within view of an electronic advertising display, the individuals being users of a social-networking system, the social-networking system comprising a graph that comprises a plurality of nodes and edges connecting the nodes, for each user at least one node in the graph corresponding to the user;
determine one or more attributes of each of one or more of the individuals from data associated with nodes in the graph corresponding to the individuals or data associated with edges connected to nodes corresponding to the individuals; and
provide the attributes for selection of an advertisement to present by the electronic advertising display to the individuals, the selection based at least in part on one or more of the attributes.
